(19) United States
(12) Patent Application Publication
(10) Pub. No.: US 2026/0171923 A1
(43) Pub. Date: Jun. 18, 2026

(54) SYNCHRONOUS RECTIFIER FOR VARIABLE FREQUENCY DRIVING OF POOL OR SPA EQUIPMENT

(71) Applicant: FLUIDRA GROUP AUSTRALIA PTY LTD, Smithfield NSW (AU)

(72) Inventors: Steve Fallon, Smithfield NSW (AU); Dime Risteski, Smithfield NSW (AU)

(73) Assignee: FLUIDRA GROUP AUSTRALIA PTY LTD, Smithfield NSW (AU)

(21) Appl. No.: 19/409,021

(22) Filed: Dec. 4, 2025

Related U.S. Application Data
(60) Provisional application No. 63/733,098, filed on Dec. 12, 2024.

(51) Int. Cl. H02M 5/46; F04D 13/06; H02M 1/14

(52) U.S. Cl. CPC H02M 5/46; H02M 1/143; F04D 13/06

(57) ABSTRACT

Systems and methods for implementing variable frequency drive for pool or spa equipment using a synchronous rectifier are disclosed. An example pool or spa system includes an alternating current (AC) input connected to an AC power source; a pool automation controller; one or more pieces of rotating pool or spa equipment; and a variable frequency drive for driving the one or more pieces of rotating pool or spa equipment. The variable frequency drive includes a synchronous rectifier configured to convert the AC input to a direct current (DC) output. The synchronous rectifier includes a chipset and one or more switching components and an inverter configured to convert the DC output to an AC drive signal at a configured frequency.

### TECHNICAL FIELD

This disclosure relates to electronic components for pool or spa systems, and more specifically, although not necessarily exclusively, to systems and methods for implementing a variable frequency drive for pool or spa equipment using a synchronous rectifier.

### BACKGROUND

Pool or spa systems typically include a number of components driven by rotating motors such as circulation pumps, booster pumps for cleaners, spa jet pumps, or blowers for air bubbles. Such equipment can be driven by an alternating current (“AC”) power supply. The AC power supply energizes the motor windings, creating a rotating magnetic field that causes the motor shaft and the attached pool or spa equipment to rotate at a speed determined by the frequency of the supplied AC signal. Electronic control circuits for such rotating components may include heat sinks or forced-air ventilation to dissipate the substantial thermal energy generated during operation, particularly in sealed outdoor equipment enclosures exposed to direct sunlight.

### SUMMARY

Systems and methods for implementing a variable frequency drive for pool or spa equipment using a synchronous rectifier are disclosed. An example pool or spa system includes an alternating current (AC) input connected to an AC power source; a pool automation controller; one or more pieces of rotating pool or spa equipment; a variable frequency drive for driving the one or more pieces of rotating pool or spa equipment, including: a synchronous rectifier configured to convert the AC input to a direct current (DC) output, including: a chipset; and one or more switching components; and an inverter, configured to convert the DC output to an AC drive signal at a configured frequency.

An example variable frequency drive for driving one or more pieces of rotating pool or spa equipment, includes a synchronous rectifier configured to convert an alternating current (AC) input to a direct current (DC) output, including a chipset and one or more switching components; and an inverter, configured to convert the DC output to an AC drive signal at a configured frequency.

An example process for driving rotating pool or spa equipment, includes receiving, by a variable frequency drive configured as part of a pool or spa system, an input AC signal and a command to generate an output AC drive signal of a particular frequency; outputting, to a synchronous rectifier, the AC signal. The process further includes generating a DC output including switching one or more rectifying elements of the synchronous rectifier using a control circuit. The process further includes smoothing the DC output of the synchronous rectifier using bulk capacitance. The process further includes inverting the smoothed DC output using inverter to generate the AC output signal. The process further includes providing the AC output signal to one or more pieces of rotating equipment.

### BRIEF DESCRIPTION OF THE DRAWINGS

FIG. 1 illustrates an example pool or spa system, according to some aspects of the present disclosure.

FIG. 2 illustrates an example of a synchronous rectifier implementation, according to some aspects of the present disclosure.

FIG. 3 illustrates a temperature chart comparing a metal-oxide-semiconductor field-effect transistor (MOSFET) of a synchronous rectifier with a diode according to embodiments of the disclosure.

FIG. 4 illustrates a flowchart of a process for implementing a variable frequency drive (VFD) using a synchronous rectifier for driving of pool or spa equipment, according to some aspects of the present disclosure.

FIG. 5 illustrates a flowchart of a computer-implemented process for operating a VFD using a synchronous rectifier for driving of pool or spa equipment, according to some aspects of the present disclosure.

FIG. 6 shows a block diagram of an example of a computing system usable in concert with a pool automation controller, according to some aspects of the present disclosure.

### DETAILED DESCRIPTION

The subject matter of the present embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. References to “pools” and “swimming pools” herein may also refer to spas or other water containing vessels used for recreation or therapy.

As mentioned above, rotating pool or spa equipment can be driven by an AC power supply. The rotational speed of the pool or spa equipment may be proportional to the frequency of the AC power supply. For example, a two-pole pump motor connected to a 60 Hz AC power supply can operate at around 3600 RPM whereas a four-pole pump motor connected to the same 60 Hz supply operates at around 1800 RPM. In these examples, the rotational speed determined by the AC supply frequency and motor pole count match the equipment's operational requirements. As used herein, “speed” can refer generally to the speed that the motor or other component of a piece of rotating pool or spa equipment is turning, typically measured in rotations per minute (“RPMs”).

However, in some cases, the determined speed may be too high or too low for the specific pool or spa application. For example, a lower pump speed may be desirable for energy savings during filtration or a higher speed for a spa blower may be desired for increased jet intensity. In these cases, direct application of AC power to rotating machinery cannot produce the desired speed. Traditional methods for adjusting motor speed for rotating pool or spa equipment may involve physically reconfiguring the pool or spa equipment, such as changing motor pulley sizes, swapping gears, or using multi-speed motors with switchable windings. These approaches require manual intervention, offer limited discrete speed options, and generally cannot provide precise or continuously variable speed control. Other approaches include multi-speed motors with selectable windings, multi-tapped autotransformers, or variable resistors; however, these approaches provide only discrete settings or introduce significant efficiency losses without precise electronic control.

In some examples, rotating pool or spa equipment can be driven using AC frequencies other than the frequency of the AC power supply using a variable frequency drive (“VFD”) which can enable the operation of equipment at various speeds. For example, a VFD may include a rectifier to convert incoming AC to DC and an inverter that synthesizes AC at selectable frequencies, along with suitable control circuitry to adjust the output frequency. Existing VFD implementations for rotating pool or spa equipment use analog components such as diodes to rectify the AC input current. However, such components may generate an undesirable amount of heat resulting in a loss of efficiency. Additionally, these analog components can be bulky, require significant cooling infrastructure, and may be susceptible to voltage spikes and electromagnetic interference that can reduce their operational lifespan.

Techniques for implementing a VFD for pool or spa equipment using a synchronous rectifier according to this disclosure can address these challenges. In one example, a pool or spa system may include an AC input connected to an AC power source and a pool automation controller for operating one or more pieces of rotating pool or spa equipment such as pumps, blowers, filters, or other pool or spa equipment with rotating components. The example pool or spa system may include a variable frequency drive for driving the one or more pieces of rotating pool or spa equipment. The variable frequency drive may include a synchronous rectifier configured to convert the AC input to a DC output. The synchronous rectifier may include a chipset and one or more switching components such as metal-oxide-semiconductor field-effect transistors (MOSFETs). The variable frequency drive may also include an inverter configured to convert the DC output to an AC signal at a configured frequency to drive the rotating pool or spa equipment. The pool automation controller can be used to operate the variable frequency drive. For example, the pool automation controller can receive an input for a particular speed to operate a pump at. The pool automation controller can determine the AC frequency needed to operate the pump at the desired speed based on the physical configuration of the pump (e.g., the number of poles in the pump stator). The pool automation controller can provide a control signal to the variable frequency drive to cause an AC output with the determined frequency.

The systems and methods according to this disclosure may use semiconductor components, such as MOSFETs, that generate significantly less heat than existing implementations. Additionally, the use of semiconductors such as MOSFETs enable a compact form factor and require significantly less cooling infrastructure than existing implementations. The use of semiconductors such as MOSFETs for switching in conjunction with modern integrated circuits can enable precision switching control to reduce voltage spikes and electromagnetic interference.

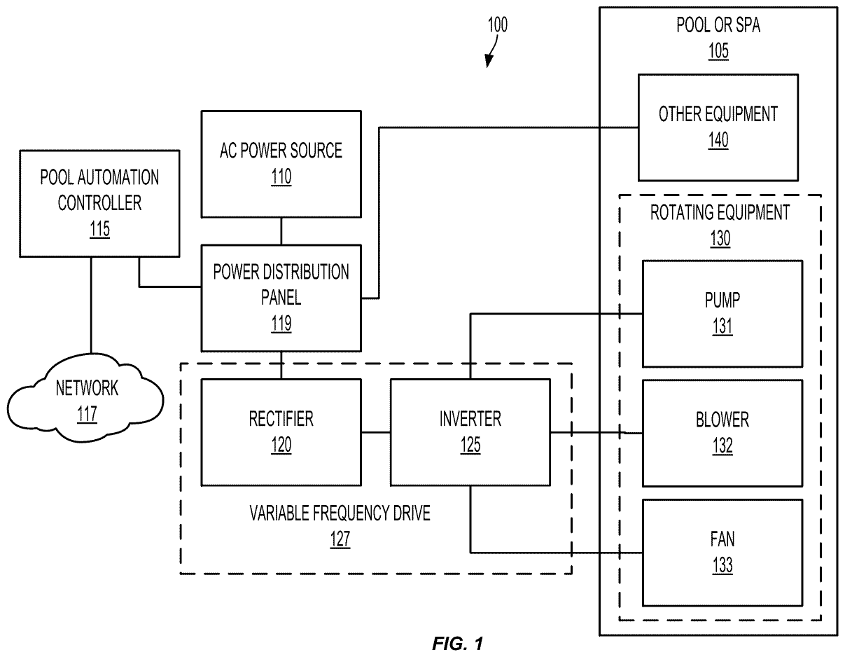

FIG. 1 illustrates an example pool or spa system 100, according to some aspects of the present disclosure. The pool or spa system 100 may include equipment associated with operating or maintaining pool or spa 105. For example, the pool or spa system 100 may include a number of pieces of equipment, shown schematically inside the pool or spa 105. The equipment may include rotating equipment 130 such as pump 131, blower 132, and fan 133. The equipment may include other equipment 140 such as heaters, filters, chlorinators, and so on. Examples of pump 131 may include circulation pumps, jet pumps, or booster pumps. Examples of blower 132 may include air blowers or ventilation blowers. Examples of fan 133 may include cooling fans or exhaust fans. Other types of motorized, rotating equipment in addition to the examples shown here can be likewise used in pool or spa 105. In general, the rotating equipment 130 in the pool or spa system 100 may be powered by AC current applied to wound stator windings to generate a rotating magnetic field that drives mechanical rotation of a magnetized rotor shaft.

In pool or spa system 100, the pool or spa equipment may be powered by AC power source 110. The AC power source 110 may provide 120V or 240V single-phase power in residential settings at typical frequencies such as 50 Hz or 60 Hz. In commercial or larger settings, the AC power source 110 can supply three-phase power at higher voltages, such as 230V or 480V, again at typical frequencies such as 50 Hz or 60 Hz. In some examples, as depicted in FIG. 1, the AC power source 110 provides power to an AC input receptacle in a power distribution panel 119. From the power distribution panel 119, power can be routed to the rotating equipment 130 as well as the other equipment 140.

Control of power distribution functions as well as control over the rotating equipment 130 and the other equipment 140 can be effected by the pool automation controller 115. The pool automation controller 115 can be used to operate pool or spa equipment by controlling the power distribution from the AC power source 110 by, for example, operating switches, junctions, relays, and other electrical devices in the power distribution panel 119. The rotating equipment 130 receives AC power via the rectifier 120 and inverter 125 that are powered from the power distribution panel 119. The rectifier 120 and inverter 125 together depict an example of a VFD 127 configuration, described below. The other equipment 140 is likewise powered via the power distribution panel 119. The other equipment 140 may receive AC or DC power from the power distribution panel 119.

The pool automation controller 115 may include one or more processing devices or electrical components for controlling the activation of, the mode of operation of, and power distribution to the rotating equipment 130 and the other equipment 140. For example, the pool automation controller 115 may include features for scheduling, remote control, or automation of pool or spa equipment. Control of pool or spa equipment may be accomplished using analog controls or digital controls, or a combination thereof. The digital controls may include electronic signals or instructions from program code executed by the one or more processing devices.

In some examples, the pool automation controller 115 may be connected to a network 117 such as a local area network, wide area network, or the Internet to enable sending and receiving of data or commands relating to operation and maintenance of the pool or spa system 100. Some example systems may not include a pool automation controller 115. In that case, the rotating equipment 130 as well as the other equipment 140 may be directly powered by the AC power source 110 by way of the power distribution panel.

In some examples, the rotating equipment 130 may be driven by one or more frequency converting devices. In general, a frequency converter can refer to a device that adjusts the frequency of the electrical power supplied to a motor, thereby controlling its speed and torque. Examples of frequency converters include VFDs, sometimes referred to as variable speed drives, cycloconverters, DC-link inverters, or matrix converters.

Pool or spa system 100 shows a VFD 127 powered by the AC power source 110 by way of the power distribution panel 119. The rectifier 120 may be configured to convert the AC voltage supplied by the AC power source 110 to a DC voltage. The inverter 125 can be configured to convert the DC voltage back to an AC voltage at variable frequencies and/or voltages to control motor speed and torque. Although pool or spa system 100 depicts VFD 127 powering several pieces of rotating equipment 130, in some examples, one VFD may be used to power each piece of rotating equipment 130. For example, one or more VFDs can be installed in parallel.

In some other examples, a single VFD 127 can be used to power a number of pieces of rotating equipment, as shown. For example, a single VFD 127 can control more than one piece of rotating equipment 130 when the motors are identical, operate synchronously, or share the same speed and torque requirements. In another example, a single VFD 127 can control more than one piece of rotating equipment 130 by regulating the frequency and voltage of the AC output supplied to each motor simultaneously or sequentially.

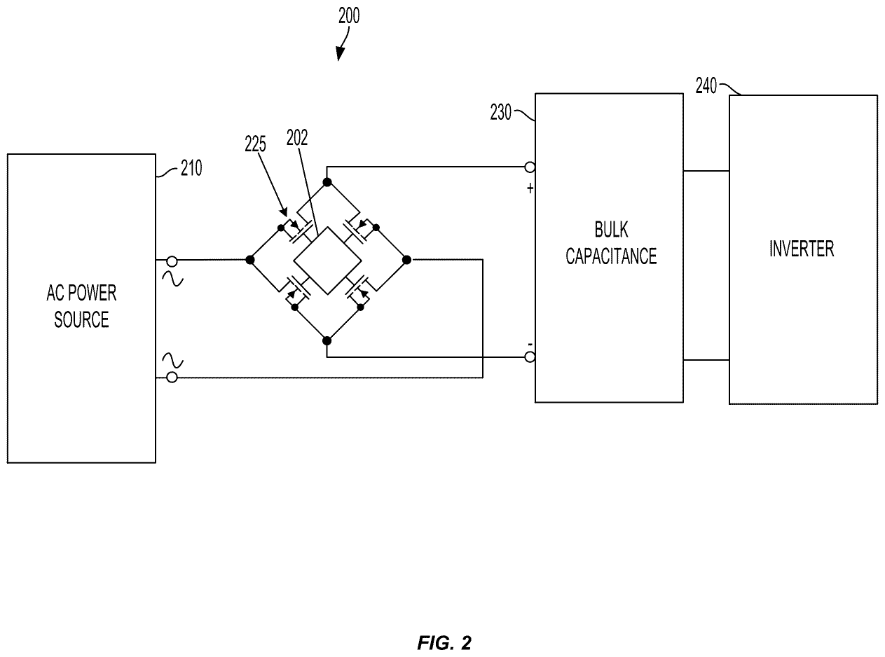

The rectifier 120 may include electronic components in a “bridge” configuration to convert AC current from the AC power source 110 to DC. The resulting DC current may be characterized by “ripples” that can be smoothed using bulk capacitance or other filtering components connected to the DC output of the rectifier 120. A detailed example of a rectifier 120 implementation is shown in FIG. 2. The inverter 125 can convert the DC current back to AC, at different frequencies and/or voltage levels using high-speed switching elements such as relays or transistors which can enable precision control over the AC output waveform.

The VFD 127 may be configured and operated using a user interface provided by the pool automation controller 115 or a standalone user interface. The VFD 127 may be configured to power one or more pieces of rotating equipment 130 such that different pieces of rotating equipment 130 can be powered at differing levels of voltage, frequency, waveform, etc. simultaneously.

For example, a maintainer or operator of the pool or spa system may input a desired pump speed of 1800 RPM into a user interface provided by the pool automation controller 115. The pool automation controller 115 can determine that a 30 Hz output frequency is required for the pump's four-pole motor and send a control signal to the VFD 127 to cause the VFD 127 to generate a 30 Hz AC output using a 60 HZ AC input signal, causing the pump to operate at the specified speed. The incoming 60 Hz AC signal can be rectified by rectifier 120 to a DC signal and then inverted back to AC at 30 Hz by the inverter 125.

FIG. 2 illustrates an example of a rectifier 120 implementation, sometimes referred to as a synchronous rectifier 200, according to some aspects of the present disclosure. The synchronous rectifier 200 may include a synchronous rectifier chipset 202, such as an LT4320 chip, which is capable of controlling a synchronous rectification process. Other chips capable of controlling a synchronous rectification process may also be used in addition to or in place of the synchronous rectifier chipset 202. The synchronous rectification process may enable rectification of current from an AC power source 210 to output DC power that can be inverted to generate an AC waveform of a specified voltage, frequency, waveform, etc.

In some examples, the synchronous rectifier 200 can use metal-oxide-semiconductor field-effect transistor (“MOSFETs”) 225 as switching components. The MOSFETs 225 can be controlled to turn on and off in sync with the AC input waveform, effectively replacing traditional diodes and reducing conduction losses. Conduction losses can refer generally to the power dissipated as heat when current flows through a forward-biased semiconductor element, such as an activated MOSFET. Operation of MOSFETs 225 can be characterized using certain electrical resistance values relating to the effective resistance presented by the MOSFETs 225 when activated (i.e., when current is flowing through the MOSFET). For example, some MOSFETs 225 can be characterized by their “on-resistance,” sometimes given by R_{DS(on)}, corresponding to the effective resistance between the drain and source terminals when the MOSFET is activated. Lower R_{DS(on)}values can correspond to lower conduction losses. As a result, the MOSFET can be more efficient and generate less heat, especially in high-current applications. If MOSFETs 225 with a sufficiently low R_{DS(on)}are selected, the heat dissipated by the rectifier will be significantly reduced. In these cases, because heat generated from the synchronous rectifier 200 is significantly reduced, the physical size of a VFD housing enclosing the synchronous rectifier 200 can be accordingly reduced because heat-dissipation components, such as those required to address the excess heat generated from internal resistances of diode or SCR rectifiers, can be omitted.

Synchronous rectification may be used in a “switched-mode” power supply or in a linear power supply. In a switched-mode power supply, output voltage can be regulated by rapidly switching the MOSFETs 225 on and off and filtering the resulting waveform with additional components such as inductors and capacitors (not shown). A linear power supply can regulate voltage by continuously varying the resistance of the MOSFETs 225 to drop excess voltage as heat. Due to a higher operating frequency of the switched-mode power supply (e.g., 50 kHz-1 MHz) compared to a linear power supply (e.g., with a frequency similar to residential AC input power of 50 or 60 Hz), the synchronous rectification at the switched-mode power supply may be used in conjunction with a smaller transformer than a transformer used in the linear power supply.

The output of the synchronous rectifier 200 is a DC signal but may have certain undesirable characteristics, such as “ripple,” which refers to small residual fluctuations or variations superimposed on the DC output. To mitigate ripple, bulk capacitance 230 can be included in the circuit to function as a smoothing element. The bulk capacitance 230 may be, for example, large, high-capacitance capacitors configured across the DC output of the synchronous rectifier 200.

The smoothed DC signal can be converted back to AC, at configured or selected frequencies, voltage levels, waveforms, etc. using inverter 240. The inverter 240 may include one or more switching components, such as MOSFETs or other semiconductor devices, configured in a bridge arrangement to generate alternating polarity at the bridge outputs. The inverter 240 may include control circuit or chipset to drive the switching components according to a pulse-width modulation or other control scheme to synthesize a desired AC waveform from the smoothed DC input at a specified frequency. The inverter 240 may operate at configurable frequencies and/or voltage levels to supply AC power suitable for downstream loads including rotating pool or spa equipment.

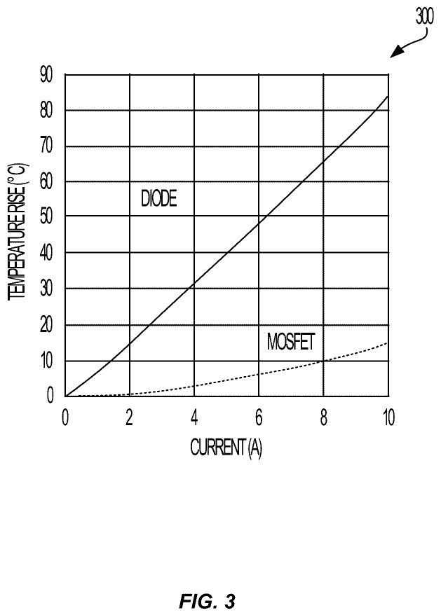

Turning to FIG. 3, a temperature chart 300 comparing a metal-oxide-semiconductor field-effect transistor (MOSFET) of the synchronous rectifier 200 with a diode is illustrated according to embodiments of the disclosure. The temperature chart 300 provides an example of the temperature rise of a typical diode (e.g., in a non-synchronous rectifier) and a typical MOSFET (e.g., in synchronous rectifier 200 of FIG. 2). As depicted, the temperature rise of the MOSFET during operation of the synchronous rectifier 200 is small relative to the temperature rise of a typical diode during operation of a non-synchronous rectifier. Accordingly, the implementation of the synchronous rectifier 200 in the VFD 127 of the pool or spa system 100 to power rotating equipment 130 may enable a reduction in a number of overall components of the pool or spa system 100 and a reduction in the physical size of the associated control equipment or electrical components. For instance, a housing configured for a VFD 127 may avoid cumbersome heatsink fins or fan systems. While synchronous rectification is described above using MOSFETs, other high current transistors or FETs may also be used.

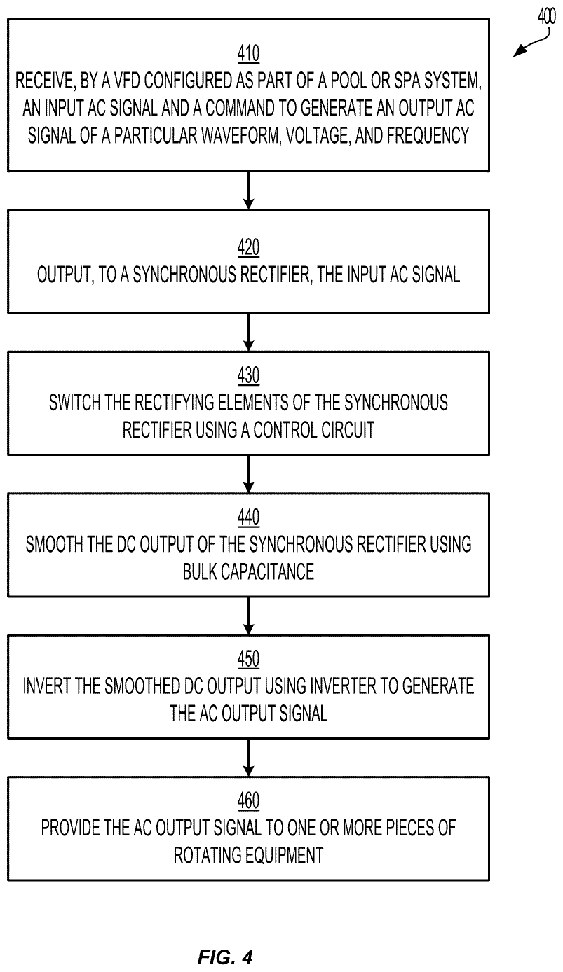

FIG. 4 illustrates a flowchart of a process 400 for implementing a VFD using a synchronous rectifier for driving of pool or spa equipment, according to some aspects of the present disclosure. The description of the process 400 in FIG. 4 will be made with reference to FIGS. 1-3, however any suitable system according to this disclosure may be used. It should be appreciated that process 400 provides a particular process for implementing a VFD using a synchronous rectifier. Other sequences of operations may also be performed according to alternative examples. For example, alternative examples of the present disclosure may perform the steps outlined below in a different order. Moreover, the individual operations illustrated by process 400 may include multiple sub-operations that may be performed in various sequences as appropriate to the individual operation. Furthermore, additional operations may be added or removed depending on the particular applications. One of ordinary skill in the art would recognize many variations, modifications, and alternatives.

At block 410, the process 400 involves receiving, by a VFD 127 configured as part of a pool or spa system 100, an input AC signal and a command to generate an output AC drive signal of a particular waveform, voltage, and frequency. For example, the VFD may be connected with an AC power source 110 via a power distribution panel 119 or other AC input component that has a fixed input voltage, frequency, phase, waveform, etc. The command may be received from a system such as the pool automation controller 115 or from a standalone user interface, such as user interface of a standalone VFD or a user interface for a piece of pool or spa equipment. The command may be an analog control signal or a digital message transmitted using protocols such as Modbus, RS-485, or Ethernet/IP.

At block 420, the process 400 involves outputting, to a synchronous rectifier 200, the AC signal. For example, the synchronous rectifier 200 can convert the AC signal into a DC signal. The AC signal may be output using wires suitable for high current and voltage levels used for driving rotating equipment 130. In some examples, the AC signal may also be filtered or conditioned through inductors or other electromagnetic interference (EMI) suppression elements to minimize electrical noise and ensure stable conversion at the synchronous rectifier 200.

At block 430, the process 400 involves switching the rectifying elements of the synchronous rectifier 200 using a control circuit. The control circuit can manage the timing and operation of the rectifying elements, such as MOSFETs. The control circuit can, for example, synchronize the MOSFET activation with the phase of the AC input signal to cause the MOSFETs to “switch on” during a first polarity to conduct current and “switch off” during a second polarity to block reverse flow. For example, if the command of block 410 specifies an increased motor speed requiring a higher output frequency, the control circuit can adjust the synchronization of the switching components (e.g., MOSFETs) to maintain efficient rectification and a stable DC bus voltage.

At block 440, the process 400 involves smoothing the DC output of the synchronous rectifier 200 using bulk capacitance 230. The bulk capacitance 230 can be used to minimize undesirable characteristics such as ripple. Excessive ripple at the inverter 240 input, as in block 450 below, can lead to inefficient operation and additional stress on the inverter's switching components, causing undesirable heat generation. The bulk capacitance 230 may include one or more capacitors connected in parallel across the DC output of the synchronous rectifier 200 to provide sufficient charge storage. During rectified waveform valleys, the stored charge in the bulk capacitance 230 can supply current to the load, maintaining a stable DC voltage and preventing voltage sag. The capacitance value of the bulk capacitance 230 may be selected based on factors such as expected load current, input frequency, or acceptable ripple magnitude to ensure reliable inverter 240 operation and to protect downstream components from voltage fluctuations and transient surges.

At block 450, the process 400 involves inverting the smoothed DC output using inverter 240 to generate the AC output drive signal. For example, the inverter 240 can receive the command to generate the output AC drive signal having a particular waveform, voltage, and frequency. The inverter 240 converts the DC voltage back into AC output signal with the desired waveform, voltage, and frequency. The inverter 240 can use techniques such as pulse-width modulation (“PWM”) to control the duration and timing of the AC output signal.

At block 460, the process 400 involves providing the AC output signal to one or more pieces of rotating equipment 130. For example, the output of the VFD 127 may be connected directly to one or more pieces of rotating equipment 130. The VFD 127 can provide an AC output signal to one or such devices, at a different voltage, frequency, or waveform for each in parallel. In some examples, the VFD 127 can be configured to output regionalized AC output signals using voltages, frequencies, or waveforms that conform to regional or national electrical power standards. For example, the VFD 127 might generate an AC output of 230V at 50 Hz for European region, or 120V at 60 Hz for regions conforming to North American standards.

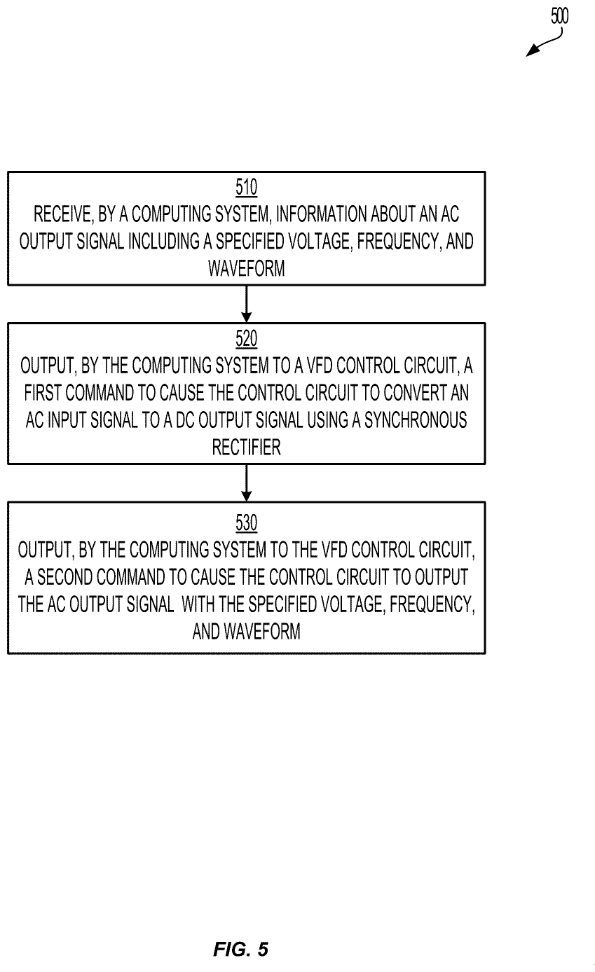

FIG. 5 illustrates a flowchart of a computer-implemented process 500 for operating a VFD using a synchronous rectifier for driving of pool or spa equipment, according to some aspects of the present disclosure. The description of the process 500 in FIG. 5 will be made with reference to FIGS. 1-3, however any suitable system according to this disclosure may be used. It should be appreciated that process 500 provides a particular process for implementing a VFD using a synchronous rectifier. Other sequences of operations may also be performed according to alternative examples. For example, alternative examples of the present disclosure may perform the steps outlined below in a different order. Moreover, the individual operations illustrated by process 500 may include multiple sub-operations that may be performed in various sequences as appropriate to the individual operation. Furthermore, additional operations may be added or removed depending on the particular applications. One of ordinary skill in the art would recognize many variations, modifications, and alternatives.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

At block 510, the process 500 involves receiving, by a computing system such as a processing device communicatively coupled with pool automation controller 115, information about an AC output signal including a specified voltage, frequency, and waveform. For example, a user interface communicatively coupled with the pool automation controller 115 can be used to input specifications of the AC output signal to drive a particular piece of pool or spa equipment. For instance, the user interface may specify that the frequency of a particular pump should be increased to cause the pump to operate at a higher speed. In some examples, the user interface can be used to specify, for example, a pump speed (e.g., an RPM setting or categorical setting such as “High”) and the computing system can determine the information about the AC output signal.

At block 520, the process 500 involves outputting, by the computing system to a VFD control circuit, a first command to cause the control circuit to convert an AC input signal to a DC output signal using a synchronous rectifier. The first command can cause the VFD control circuit to drive the MOSFET rectifying elements of the synchronous rectifier 200 to generate a DC signal that is output to the inverter 240. The VFD control circuit can, in response to the first command, modulate the gate signals of the MOSFET rectifying elements in synchronization with the phase of the incoming AC waveform.

At block 530, the process 500 involves outputting, by the computing system to the VFD control circuit, a second command to cause the control circuit to output the AC output signal with the specified voltage, frequency, and waveform. The second command can cause the control circuitry of the inverter 240 to execute program code or to operate to convert the DC signal output of the synchronous rectifier to an AC output signal with the specified voltage, frequency, and waveform. For example, the inverter 240 may include control circuitry that employs pulse-width modulation (PWM) techniques to synthesize the AC output waveform from the DC output bus of the synchronous rectifier to adjust the switching sequences and duty cycles of the inverter transistors to cause the specified voltage, frequency, and waveform across the AC output of the inverter 240.

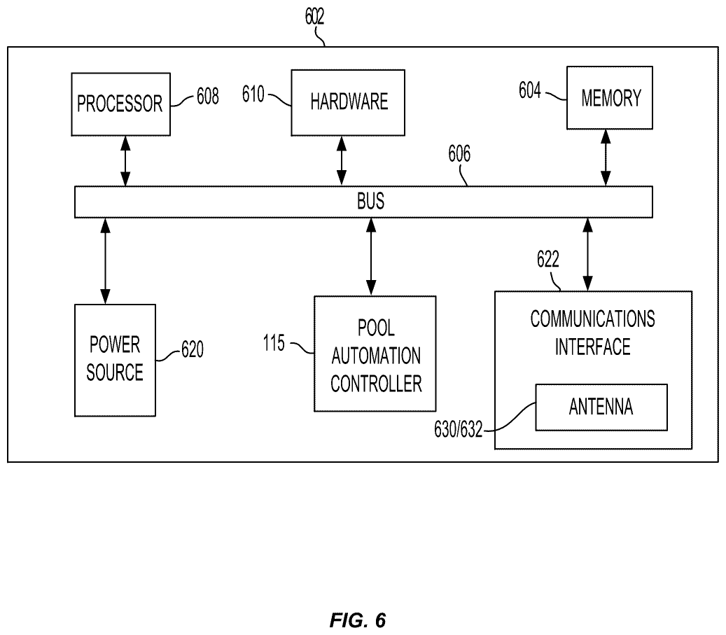

FIG. 6 shows a block diagram of an example of a computing system 602, such as a computing processing device communicatively coupled with the pool automation controller 115 of FIG. 1, usable in concert with the pool automation controller 115, according to some aspects of the present disclosure. In some examples, the components shown in FIG. 6 (e.g., the power source 620, pool automation controller 115, communications interface 622, processor 608, memory 604, and hardware 610) can be integrated into a single structure. For example, the components can be within a single housing, such as within the housing of the pool automation controller 115. In other examples, the components shown in FIG. 6 can be distributed (e.g., in separate housings) and in electrical communication with each other.

The computing system 602 can include the processor 608, the memory 604, and a bus 606. The processor 608 can execute one or more operations for operating the computing system 602. The processor 608 can execute instructions stored in the memory 604 to perform the operations. The processor 608 can include one processing device or multiple processing devices. Non-limiting examples of the processor 608 include a Field-Programmable Gate Array (“FPGA”), an application-specific integrated circuit (“ASIC”), a microprocessor, etc.

The processor 608 can be communicatively coupled to the memory 604 via the bus 606. The non-volatile memory 604 may include any type of memory device that retains stored information when powered off. Non-limiting examples of the memory 604 include electrically erasable and programmable read-only memory (“EEPROM”), flash memory, or any other type of non-volatile memory. In some examples, at least some of the memory 604 can include a non-transitory medium from which the processor 608 can read instructions. A non-transitory computer-readable medium can include electronic, optical, magnetic, or other storage devices capable of providing the processor 608 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which the processor 608 can read instructions. The instructions can include processor-specific instructions generated by a compiler or an interpreter from code written in any suitable computer-programming language, including, for example, C, C++, C#, etc.

The computing system 602 can include a power source 620. In some examples, the power source 620 can include the synchronous rectifier 200 (e.g., for rectifying an AC power source). The computing system 602 can include a communications interface 622. The communications interface 622 can include a wireless interface, which can include one or more antennas 630 or 632. In some examples, part of the communications interface 622 can be implemented in software. For example, the communications interface 622 can include instructions stored in memory 604.

The computing system 602 can use the communications interface 622 to communicate with one or more external devices. In some examples, the communications interface 622 can amplify, filter, demodulate, demultiplex, frequency shift, and otherwise manipulate a signal received from an external device, such as a pool or spa system component. The communications interface 622 can transmit a signal associated with the received signal to the processor 608 or the hardware 610. The processor 608 or hardware 610 can receive and analyze the signal to retrieve data associated with the received signal.

In some examples, the computing system 602 can analyze the data from the communications interface 622 and perform one or more functions. For example, the computing system 602 can generate a response based on the data. The computing system 602 (e.g., using the processor 608) can cause a response signal associated with the response to be transmitted to the communications interface 622. The communications interface 622 can generate a transmission signal (e.g., via the antenna 630 or 632) to communicate the response to a remote computing device. For example, the communications interface 622 can amplify, filter, modulate, frequency shift, multiplex, and otherwise manipulate the response signal to generate the transmission signal. In some examples, the communications interface 622 can encode data within the response signal using a modulation technique (e.g., frequency modulation, amplitude modulation, or phase modulation) to generate the transmission signal. The communications interface 622 can transmit the transmission signal to the antenna 630 or 632. The antenna 630 or 632 can receive the transmission signal and responsively generate a wireless communication. In this manner, the computing system 602 can receive, analyze, and respond to communications from an external electronic device.

In some examples, the computing system 602 can include more, fewer, or different components than those shown in FIG. 6. Additionally or alternatively, the components of the computing system 602 can be configured differently than the configuration shown in FIG. 6. For example, the computing system 602 may not include the processor 608, the memory 604, or both. In such an example, the processor 608, the memory 604, or both may be arranged as a distributed computing device.

### General Considerations

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied. For example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

These examples are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the invention. Finally, references to “pools” and “swimming pools” herein may also refer to spas or other water-containing vessels used for recreation, training, or therapy.

What is claimed is:

1. A pool or spa system, comprising:
an alternating current (AC) input connected to an AC power source;
one or more pieces of rotating pool or spa equipment;
a variable frequency drive for driving the one or more pieces of rotating pool or spa equipment, comprising:
a synchronous rectifier configured to convert the AC input to a direct current (DC) output, comprising:
a chipset; and
one or more switching components; and
an inverter, configured to convert the DC output to an AC drive signal at a configured frequency.

2. The pool or spa system of claim 1, wherein the one or more switching components are metal-oxide-semiconductor field-effect transistors (MOSFETs).

3. The pool or spa system of claim 2, wherein:
the synchronous rectifier comprises four MOSFETs; and
the four MOSFETs are connected to the chipset in a bridge configuration.

4. The pool or spa system of claim 1, wherein the synchronous rectifier further comprises:
one or more capacitors connected in parallel across the DC output of the synchronous rectifier.

5. The pool or spa system of claim 1, wherein the variable frequency drive further comprises:
a plurality of synchronous rectifiers and a plurality of respective inverters, each synchronous rectifier and inverter pair being connected to a respective piece of rotating pool or spa equipment.

6. The pool or spa system of claim 1, wherein the one or more pieces of rotating pool or spa equipment comprise at least one of a pump, fan, or blower.

7. The pool or spa system of claim 1, wherein:
the variable frequency drive is connected to a plurality of pieces of pool or spa equipment; and
the variable frequency drive is configured to provide AC power at the configured frequency to the plurality of pieces of pool or spa equipment.

8. The pool or spa system of claim 1, wherein:
the pool or spa system further comprises a pool automation controller; and
the pool automation controller comprises a user interface configured to receive a command to generate, by the variable frequency drive, the AC drive signal at a specified frequency.

9. The pool or spa system of claim 1, further comprising:
a network interface configured to receive, from a remote user interface, a command to generate, by the variable frequency drive, the AC drive signal at a specified frequency.

10. A variable frequency drive for driving one or more pieces of rotating pool or spa equipment, comprising:
a synchronous rectifier configured to convert an alternating current (AC) input to a direct current (DC) output, comprising:
a chipset; and
one or more switching components; and
an inverter, configured to convert the DC output to an AC drive signal at a configured frequency.

11. The variable frequency drive of claim 10, wherein the one or more switching components are MOSFETs.

12. The variable frequency drive of claim 11, wherein:
the synchronous rectifier comprises four MOSFETs; and
the four MOSFETs are connected to the chipset in bridge configuration.

13. The variable frequency drive of claim 11, wherein the synchronous rectifier further comprises:
one or more capacitors connected in parallel across the DC output of the synchronous rectifier.

14. The variable frequency drive of claim 11, further comprising:
a plurality of synchronous rectifiers and a plurality of respective inverters, each synchronous rectifier and inverter pair being connected to a respective piece of rotating pool or spa equipment.

15. The variable frequency drive of claim 11, wherein:
the variable frequency drive is configured to receive a command to generate, by the variable frequency drive, the AC drive signal at a specified frequency.

16. A method for driving rotating pool or spa equipment, comprising:
receiving, by a variable frequency drive configured as part of a pool or spa system, an input AC signal and a command to generate an AC drive signal of a particular frequency;
outputting, to a synchronous rectifier, the input AC signal;
generating a DC output comprising switching one or more rectifying elements of the synchronous rectifier using a control circuit;
smoothing the DC output of the synchronous rectifier using bulk capacitance;
inverting the smoothed DC output using inverter to generate the AC drive signal; and
providing the AC drive signal to one or more pieces of rotating equipment.

17. The method of claim 16, wherein:
the one or more rectifying elements of the synchronous rectifier comprise one or more switching components; and
the synchronous rectifier further comprises a chipset configured to control a synchronous rectification process.

18. The method of claim 17, wherein the one or more switching components are MOSFETs.

19. The method of claim 18, wherein:
the synchronous rectifier comprises four MOSFETs; and
the four MOSFETs are connected to the chipset in bridge configuration.

20. The method of claim 16, further comprising:
receiving, from a user interface, an indication of a speed for a first piece of pool or spa equipment; and
determining, based on the indication, the particular frequency.
